(19) United States
(12) Patent Application Publication
(10) Pub. No.: US 2025/0208352 A1
(43) Pub. Date: Jun. 26, 2025

(54) Polarization Controller Based on On-chip Mode Conversion

(71) Applicant: ZHEJIANG UNIVERSITY, Hangzhou (CN)

(72) Inventors: Daoxin DAI, Hangzhou (CN); Weike ZHAO, Hangzhou (CN)

(73) Assignee: ZHEJIANG UNIVERSITY, Hangzhou (CN)

(21) Appl. No.: 18/845,439

(22) PCT Filed: Apr. 14, 2023
(86) PCT No.: PCT/CN2023/088279

§ 371 Date: Oct. 15, 2024

(30) Foreign Application Priority Data
Mar. 10, 2022 (CN) 202210231798.5

(51) Int. Cl. G02B 6/27; G02B 6/293; G02F 1/01

(52) U.S. Cl. CPC G02B 6/2773; G02B 6/2766; G02B 6/29352; G02F 1/0142

(57) ABSTRACT

A polarization controller based on on-chip mode conversion is provided. An input end-face coupler is connected to an input end of an input polarization-dependent mode converter through an input phase shifter. An output end of the input polarization-dependent mode converter is connected to an input end of a multi-mode 1×1 Mach-Zehnder interferometer (MZI), and an output end of the multi-mode 1×1 MZI is connected to an input end of an output polarization-dependent mode converter. An output end of the output polarization-dependent mode converter is connected to an output end-face coupler through an output phase shifter. The input end and the output end of the multi-mode 1×1 MZI are respectively connected to the input polarization-dependent mode converter and the output polarization-dependent mode converter to form a polarization insensitive beam splitting structure. The polarization controller can convert any two arbitrary polarization states, and has a compact structure and a large bandwidth.

### CROSS REFERENCE TO THE RELATED APPLICATIONS

This application is the national phase entry of International Application No. PCT/CN2023/088279, filed on Apr. 14, 2023, which is based upon and claims priority to Chinese Patent Application No. 202210231798.5, filed on Mar. 10, 2022, the entire contents of which are incorporated herein by reference.

### TECHNICAL FIELD

The present disclosure relates to an on-chip polarization controller, and in particular, to a polarization controller based on on-chip mode conversion, which achieves a high extinction ratio, a low insertion loss, a large bandwidth, and a large manufacturing tolerance.

### BACKGROUND

Polarization control has an important application value in many scenarios, such as polarization diversity networks, coherent optical communication, and quantum communication. Currently, commonly used polarization controllers can be implemented based on an optical fiber, a wave plate, a mechanical structure, and the like, but have disadvantages such as a large volume, low isolation, and inconvenient adjustment. Characterized by a large refractive index difference and an asymmetric structure, silicon optical waveguides are very suitable for designing highly-integrated and high-performance polarization control devices, including a polarizer, a polarization rotator, a polarization beam splitter, a polarization rotator-splitter, and the like. However, currently, most polarization control devices are static devices that cannot be regulated or controlled. A polarization controller that can dynamically adjust a ratio of two polarization components and achieve flexible conversion between any two polarization states is an important device for building a flexible polarized optical network. At present, there are few reported dynamic polarization controllers, which can be implemented based on mode hybridization, Berry's phase, partially etched waveguides, and other schemes. However, these schemes have problems such as a large size, a small bandwidth, and a complex manufacturing process. Therefore, a high-performance polarization controller has high research value.

### SUMMARY

To solve the problems in BACKGROUND, the present disclosure is intended to provide an on-chip polarization controller with a compact structure, a high extinction ratio, a low insertion loss, a large bandwidth, and a large manufacturing tolerance, which can dynamically adjust and convert any two polarization states effectively and has important application value.

The present disclosure utilizes an on-chip polarization-dependent mode converter to simultaneously achieve lossless adiabatic mode evolution between TE₀ modes and mode hybridization conversion between TM₀ and TE₁ modes, and uses a phase shifter to control intensity and a phase relationship for the TE₀ and the TM₀ in a main waveguide, thereby converting any two polarization states (circular polarization, linear polarization, and elliptical polarization). The present disclosure has advantages of a compact structure, a high extinction ratio, low crosstalk, and a large bandwidth, and can be applied to polarization control in an optical fiber communication system, an on-chip optical interconnect system, a quantum communication system, and related optical communication systems.

An extinction ratio in the present disclosure is defined as follows: Energy of the TE₀ and the TM₀ output by a switch is P₁ and P₂ respectively (assuming P₂>P₁), and the extinction ratio is 10·log (P₂/P₁). A higher extinction ratio leads to a higher switching efficiency. An insertion loss is an additional loss introduced by the entire device. A bandwidth is a wavelength range in which the extinction ratio of the device is greater than a specified value, and a process tolerance is an impact of broadening of a waveguide on the extinction ratio of the device in a manufacturing process of the waveguide.

The present disclosure adopts the following technical solutions.

The present disclosure includes an input end-face coupler, an input phase shifter, an input polarization-dependent mode converter, a multi-mode 1×1 Mach-Zehnder interferometer (MZI) with a 1×2 multi-mode beam splitter, an output polarization-dependent mode converter, an output phase shifter, and an output end-face coupler, where an output end of the input end-face coupler is connected to an input end of the input polarization-dependent mode converter through the input phase shifter, another end of the input polarization-dependent mode converter is connected to an input end of the multi-mode 1×1 MZI, an output end of the multi-mode 1×1 MZI is connected to an input end of the output polarization-dependent mode converter, and an output end of the output polarization-dependent mode converter is connected to the output end-face coupler through the output phase shifter; and

the input end and the output end of the multi-mode 1×1 MZI are respectively connected to the input polarization-dependent mode converter and the output polarization-dependent mode converter through a multi-mode beam splitter and a polarization-dependent mode converter to form a polarization insensitive beam splitting structure. Polarization insensitive beam splitting with a large bandwidth and a large manufacturing tolerance is achieved through the polarization insensitive beam splitting structure.

The MZI is a Mach Zehnder interference structure.

The multi-mode 1×1 MZI mainly includes an input-end 1×2 multi-mode beam splitter, an input-end S-shaped bent waveguide, a phase shifter, an output-end S-shaped bent waveguide, and an output-end 2×1 multi-mode beam combiner; the output-end 2×1 multi-mode beam combiner and the input-end 1×2 multi-mode beam splitter are symmetrically arranged at an end portion of the multi-mode 1×1 MZI; an input end of the input-end 1×2 multi-mode beam splitter is connected to the input polarization-dependent mode converter, and two output ends of the input-end 1×2 multi-mode beam splitter are respectively connected to one end of phase shifters through an S-shaped bent waveguide; and the other end of these two phase shifters are respectively connected to two input ends of the output-end 2×1 multi-mode beam combiner through an S-shaped bent waveguide respectively, and the output end of the 2×1 multi-mode beam combiner is connected to a polarization-dependent mode converter.

For the polarization controller in the present disclosure, a mode input by the input end-face coupler is any polarization state, and a mode output by the output end-face coupler is any desired polarization state. The any polarization state includes circular polarization, linear polarization, elliptical polarization, and other polarization states.

A core region of the input polarization-dependent mode converter/the output polarization-dependent mode converter is a graded tapered waveguide with a vertical asymmetry cross-section, the graded tapered waveguide widens gradually, a narrow end of the graded tapered waveguide is connected to the input phase shifter/the output phase shifter, and a wide end of the graded tapered waveguide is connected to the multi-mode 1×1 MZI; and widths of the two ends of the graded tapered waveguide span a width of hybridization region between TM₀ and TE₁ modes.

The graded tapered waveguide with the vertical asymmetry cross-section is of a tapered ridge waveguide structure, a waveguide structure with unequal refractive indices for upper and lower cladding layers, a waveguide structure with a non-perpendicular inclined sidewall, or the like.

The input-end 1×2 multi-mode beam splitter and the output-end 2×1 multi-mode beam combiner are of a Y-branch structure, and the Y branch is constituted by three adiabatically evolved waveguides, where one adiabatically evolved waveguide is located in a middle between the other two adiabatically evolved waveguides to serve as a central waveguide, the other two adiabatically evolved waveguides on two sides of the central waveguide are symmetrical beam splitting waveguides, the central waveguide narrows from one end of the polarization-dependent mode converter to a center of the multi-mode 1×1 MZI, each symmetrical beam splitting waveguide widens from one end of the polarization-dependent mode converter to the center of the multi-mode 1×1 MZI, and a gap exists between the central waveguide and the other two adiabatically evolved waveguides.

A wide end of the central waveguide is connected to a wide end of a graded tapered waveguide, and a width of the wide end of the graded tapered waveguide is identical to a width of the wide end of the central waveguide; and wide ends of the two symmetrical beam splitting waveguides are respectively connected to respective S-shaped bent waveguides.

The input end-face coupler/the output end-face coupler adopts an inverted-cone waveguide design, that is, a waveguide width gradually narrows from a center of the polarization controller towards the input/output end of the input end-face coupler/the output end-face coupler.

The input end-face coupler, the input phase shifter, the input polarization-dependent mode converter, the multi-mode 1×1 MZI, the output polarization-dependent mode converter, the output phase shifter, and the output end-face coupler are all integrated on a same silicon substrate through a semiconductor technology.

The present disclosure has the following beneficial effects:

The polarization-dependent mode converter used in the present disclosure is based on mode hybridization and mode evolution theories of a tapered ridge waveguide, and can simultaneously achieve conversion between the TM₀ and TE₁ modes and lossless transmission of a TE₀ mode. This working mechanism has advantages of a high extinction ratio, a large bandwidth, and a large tolerance.

The 1×2 multi-mode beam splitter used in the present disclosure adopts a three-core adiabatic mode evolution structure, which can simultaneously achieve 50%: 50% beam splitting between the TE₀ and TE₁ modes, and can convert any two arbitrary polarization states. The present disclosure has advantages of a compact structure, a large bandwidth, a large tolerance, a low power consumption, and the like.

### BRIEF DESCRIPTION OF THE DRAWINGS

FIG. 1 is a schematic diagram of an embodiment of the present disclosure;

FIG. 2 is a schematic structural diagram of an enlarged polarization-dependent mode converter and multi-mode 1×2 beam splitter according to an embodiment;

FIG. 3 shows a cross-section of a ridge waveguide according to an embodiment;

FIGS. 4A-4B show a transmission spectrum when phase shifters of two alarms of a polarization controller are not working (Δφ=0) according to an embodiment, where FIG. 4A represents that TE₀ is input, and FIG. 4B represents that TM₀ is input; and

FIGS. 5A-5B show a transmission spectrum when phase shifters of two arms a polarization controller are working (Δφ=π) according to an embodiment, where FIG. 5A represents that TE₀ is input, and FIG. 5B represents that TM₀ is input.

### DETAILED DESCRIPTION OF THE EMBODIMENTS

The present disclosure will be further described in detail below in conjunction with the accompanying drawings and embodiments.

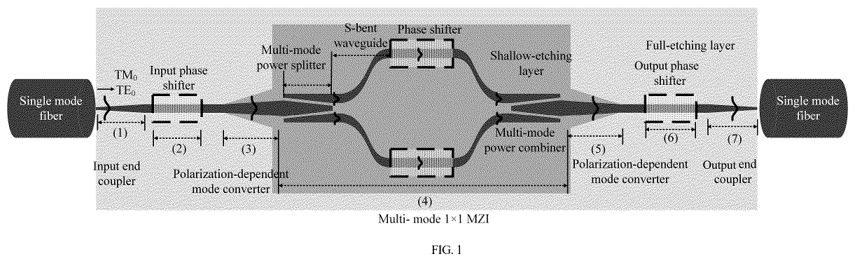

As shown in FIG. 1, input end-face coupler 1, input phase shifter 2, input polarization-dependent mode converter 3, multi-mode 1×1 MZI 4 with a 1×2 multi-mode beam splitter, output polarization-dependent mode converter 5, output phase shifter 6, and output end-face coupler 7 are included. An end of the input end-face coupler 1 is connected to a single mode fiber (SMF). An output end of the input end-face coupler 1 is connected to an input end of the input polarization-dependent mode converter 3 through the input phase shifter 2, and another end of the input polarization-dependent mode converter 3 is connected to an input end of the multi-mode 1×1 MZI 4. An output end of the multi-mode 1×1 MZI 4 is connected to an input end of the output polarization-dependent mode converter 5, and an output end of the output polarization-dependent mode converter 5 is connected to the output end-face coupler 7 through the output phase shifter 6. The input end and the output end of the multi-mode 1×1 MZI 4 are respectively connected to the input polarization-dependent mode converter 3 and the output polarization-dependent mode converter 5 to form a polarization insensitive beam splitting structure.

As shown in FIG. 1, the multi-mode 1×1 MZI 4 mainly includes an input-end 1×2 multi-mode beam splitter, an input-end S-shaped bent waveguide, a phase shifter, an output-end S-shaped bent waveguide, and an output-end 2×1 multi-mode beam combiner. The output-end 2×1 multi-mode beam combiner and the input-end 1×2 multi-mode beam splitter are symmetrically arranged at an end portion of the multi-mode 1×1 MZI 4. An input end of the input-end 1×2 multi-mode beam splitter is connected to the input polarization-dependent mode converter 3, and two output ends of the input-end 1×2 multi-mode beam splitter are respectively connected to one end of phase shifters through an S-shaped bent waveguide. The other end of these two phase shifters are respectively connected to two input ends of the output-end 2×1 multi-mode beam combiner through an S-shaped bent waveguide respectively, and an output end of the output-end 2×1 multi-mode beam combiner is connected to the output polarization-dependent mode converter 5.

Light input into the polarization controller may be a TE₀ mode (TE₁ cannot be input), a TM₀ mode, or a hybrid mode of the TE₀ mode and the TM₀ mode. The input-end 1×2 multi-mode beam splitter is configured to divide the input TE₀ mode into two TE₀ modes with a same phase, or divide the input TE₁ mode into two TE₀ modes with a phase difference of T.

The phase shifter is located in a middle between two arms of the multi-mode 1×1 MZI 4 and configured to control a phase difference between TE₀ modes of the two arms of the multi-mode 1×1 MZI 4.

The input phase shifter 2/the output phase shifter 6 is configured to control and adjust a phase difference between the TE₀ mode and the TM₀ mode for output light. Due to an asymmetric structure of a silicon waveguide, the TE₀ mode and the TM₀ mode have different energy ratios in a core layer of the silicon waveguide, and a thermo-optic coefficient of silicon is much greater than that of a silicon dioxide in a cladding layer. Therefore, a thermo-optic phase shifter can change the phase difference between the TE₀ mode and the TM₀ mode. The phase shifters of the two arms of the MZI are configured to adjust a phase difference between TE₀ modes in waveguides of the two arms, thereby adjusting the energy ratios of the TE₀ mode and the TM₀ mode.

One end of the input polarization-dependent mode converter 3/the output polarization-dependent mode converter 5 is connected to the input/output end-face coupler, and a core region is a graded tapered waveguide with a vertical asymmetry cross-section. The graded tapered waveguide widens gradually, a narrow end of the graded tapered waveguide is connected to the input phase shifter 2/the output phase shifter 6, and a wide end of the graded tapered waveguide is connected to the multi-mode 1×1 MZI 4. Widths of the two ends of the graded tapered waveguide span a width of hybridization region between the TM₀ mode and the TE₁ mode. That is, the width of the hybridization between the TM₀ mode and the TE₁ mode is less than a width of the wide end of the graded tapered waveguide and greater than a width of the narrow end of the graded tapered waveguide. In this case, when a signal in the TE₁ mode or the TM₀ mode is input into the polarization controller, the graded tapered waveguide converts the TM₀/TE₁ mode to its TE₁/TM₀ mode. When a signal in the TE₀ mode is input into the polarization controller, the input TE₀ mode passes through the graded tapered waveguide adiabatically and losslessly.

Th polarization-dependent mode converter is designed based on mode hybridization and evolution of a tapered, vertical, and asymmetric waveguide. An effective refractive index (Neff) of a mode of a ridge waveguide is calculated to find the width of the mode hybridization between the TM₀ mode and the TE₁ mode on a dispersion curve. That is, around the width, Nefs of the two modes are close to each other. Therefore, when the TM₀ mode and the TE₁ mode pass through a ridge waveguide with a width changing taperedly near the hybridization point, they can be mutually converted efficiently.

Therefore, when the tapered waveguide spans the width of the hybridization between the TM₀ mode and the TE₁ mode, the TM₀ (TE₁) mode of the graded tapered waveguide can be converted into the TE₁ (TM₀) mode, and the input TE₀ mode is transmitted adiabatically and losslessly.

As shown in FIG. 3, the graded tapered waveguide with the vertical asymmetry cross-section is of a tapered ridge waveguide structure, a waveguide structure with unequal refractive indices for upper and lower cladding layers, a waveguide structure with a non-perpendicular tilted sidewall, or the like.

As shown in FIG. 3, a waveguide cross-section of a device body is the ridge waveguide, and above the waveguide is a metal electrode that controls the phase difference between the two arms of the MZI based on a thermo-optic effect of the silicon waveguide.

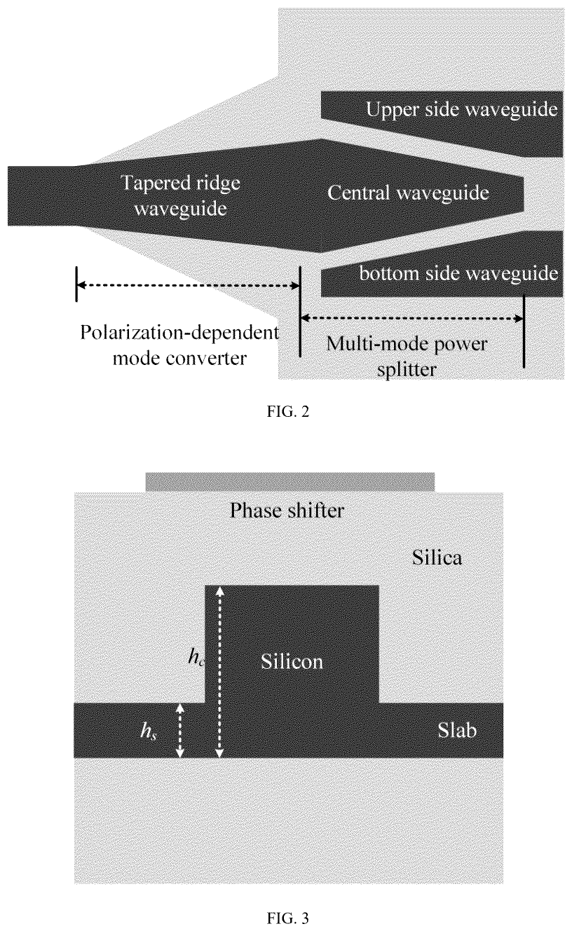

As shown in FIG. 2, the input-end 1×2 multi-mode beam splitter and the output-end 2×1 multi-mode beam combiner are of a Y-branch structure, and the Y branch is constituted by three adiabatically evolved waveguides. One adiabatically evolved waveguide is located in a middle between the other two adiabatically evolved waveguides to serve as a central waveguide, and the other two adiabatically evolved waveguides on two sides of the central waveguide are symmetrical beam splitting waveguides. The central waveguide narrows from one end of the polarization-dependent mode converter to a center of the multi-mode 1×1 MZI 4, and each symmetrical beam splitting waveguide widens from one end of the polarization-dependent mode converter to the center of the multi-mode 1×1 MZI 4. The central waveguide and the symmetrical beam splitting waveguides all satisfy an adiabatic condition, and a gap exists between the central waveguide and the other two adiabatically evolved waveguides. Preferably, the gap is uniform and the same from one end of the polarization-dependent mode converter to the center of the multi-mode 1×1 MZI 4.

A wide end of the central waveguide is connected to the wide end of the graded tapered waveguide through the tapered waveguide, and the width of the wide end of the graded tapered waveguide is the same as (may be different from) a width of the wide end of the central waveguide. Wide ends of the two symmetrical beam splitting waveguides are respectively connected to respective S-shaped bent waveguides.

A straightly inclined gap is formed between the central waveguide and the other two adiabatically evolved waveguides, which gradually approaches the centerline of the central waveguide from the polarization-dependent mode converter to the multi-mode 1×1 MZI 4.

In specific implementation, the multi-mode beam splitter adopts a three-core adiabatically evolved Y-branch structure to achieve 1:1 beam splitting between the TE₀ mode and the TE₁ mode. In other words, 50%: 50% beam splitting between the TE₀ mode and the TE₁ mode can be simultaneously achieved. Width ratios of a middle waveguide and waveguides on two sides in a three-core waveguide are controlled, such that the TE₀ mode and the TE₁ mode are mainly confined to the central waveguide at a start end, and evenly distributed in the narrow waveguides on the two sides at a tail end, thereby achieving wavelength-insensitive 1:1 beam splitting between the TE₀ mode and the TE₁ mode.

Light that is in any polarization state and input into the polarization controller from the SMF can be decomposed into two fundamental modes TE₀ and TM₀ in the silicon waveguide. The TE₀ mode losslessly passes through the input polarization-dependent mode converter, and then is divided into two TE₀ modes with a same phase through the multi-mode beam splitter before entering the two arms of the MZI. Due to the mode hybridization, the TM₀ mode evolves into the TE₁ mode through the input polarization-dependent mode converter. The TE₁ mode is divided into two TE₀ modes with a phase difference of π by a multi-mode 3-dB beam splitter before entering the two arms of the MZI. The phase shifters of the two arms of the MZI can be used to adjust the phase difference between the two TE₀ modes of the two arms of the MZI, thereby controlling a proportion of the TE₀ mode to the TE₁ mode at the output end of the MZI. The TE₀ and the TE₁ output by the MZI are converted back to the TE₀ and TM₀ modes by the polarization-dependent mode converter.

Finally, after being adjusted by the output phase shifter, a phase relationship between the TE₀ mode and the TM₀ mode is coupled into the SMF through the end-face coupler to obtain any output polarization state.

The input end-face coupler 1/the output end-face coupler 7 adopts an inverted-cone waveguide design, that is, a waveguide width gradually narrows from a center of the polarization controller towards an input/output end input of the input end-face coupler 1/the output end-face coupler 7 to amplify a mode spot of a waveguide, thereby achieving efficient coupling with the SMF.

As shown in FIG. 3, the input end-face coupler 1/the output end-face coupler 7 and the phase shifters of the two arms of the multi-mode 1×1 MZI 4 are implemented based on thermo-optic and electro-optic effects of the waveguide and other methods.

In specific implementation, the input end-face coupler 1, the input phase shifter 2, the input polarization-dependent mode converter 3, the multi-mode 1×1 MZI 4, the output polarization-dependent mode converter 5, the output phase shifter 6, and the output end-face coupler 7 are all integrated on a same silicon substrate through a semiconductor technology.

The following describes a working process of the present disclosure as the polarization controller:

Light that is in any polarization state and input into the polarization controller from the SMF can be decomposed into two fundamental modes TE₀ and TM₀ input into the silicon waveguide. The TE₀ mode losslessly passes through the input polarization-dependent mode converter, and then is divided into two TE₀ modes with a same phase through the multi-mode beam splitter before entering the two arms of the MZI. Due to the mode hybridization, the TM₀ mode evolves into the TE₁ mode through the input polarization-dependent mode converter. The TE₁ mode is divided into two TE₀ modes with a same phase through the multi-mode beam splitter before entering the two arms of the MZI. The phase shifters of the two arms of the MZI can be used to adjust the phase difference between the two TE₀ modes of the two arms of the MZI, thereby achieving a proportion of the TE₀ mode to the TE₁ mode at the output end of the MZI. The TE0 and the TE₁ output by the MZI are converted back to the TE₀ and TM₀ modes by the polarization-dependent mode converter. Finally, after being adjusted by the output phase shifter, a phase relationship between the TE₀ mode and the TM₀ mode is coupled into the SMF through the end-face coupler to obtain any output polarization state.

Therefore, an energy ratio of the TE₀ to the TM₀ is controlled through the phase shifter of the MZI, and the phase difference between the TE₀ and the TM₀ is controlled through the output phase shifter, such that any two polarization states can be converted. The phase shifter can be implemented based on the thermo-optic effect, the electro-optic effect, and other mechanisms. A specific embodiment of the present disclosure is as follows:

A silicon nanowire optical waveguide is selected based on a silicon-on-insulator (SOI) material. A core layer of the silicon nanowire optical waveguide is made of a silicon material, a thickness of the waveguide is 220 nm, and a refractive index is 3.4744. A ridge waveguide has a slab thickness of 70 nm and a refractive index of 3.4744, and its lower and upper cladding layers are made of SiO2, with a thickness of 2 μm and a refractive index of 1.444. A structure of the device is shown in FIG. 1.

For input end-face coupler 1/output end-face coupler 7, a linear inverted-cone waveguide is used, with a width being 0.45 μm for a wide end and being 0.16 μm for a narrow end close to an SMF. A length of an adiabatic tapered waveguide is 150 μm, ensuring efficient coupling between TE₀ and TM₀ modes and the SMF. Input phase shifter 2/output phase shifter 6 is a straight waveguide with a width of 0.45 μm and a length of 100 μm. A metal electrode is located above the SiO2 cladding layer to heat a waveguide region, causing a phase shift to the TE₀ and the TM₀. Width ranges of ridge waveguides of polarization-dependent mode converters 3 and 5 should span a 0.52 μm width of mode hybridization between the TM₀ mode and the TE₁ mode. Herein, a width of a start end and a width of a tail end are respectively selected as 0.45 μm and 0.8 μm, and corresponding slab widths at the start and tail ends are respectively 0.45 μm and 2 μm. A converter length is 60 μm. A multi-mode beam splitter in multi-mode MZI 4 adopts a three-core adiabatic mode evolution structure shown in FIG. 2. That is, at a start end, a central waveguide is wide enough and waveguides on two sides should be narrow enough. At an output end, the central waveguide should be narrow enough and the waveguides on the two sides should be wide enough. Herein, selected start-end and tail-end widths of the central waveguide are respectively 0.9 μm and 0.12 μm. Selected start-end and tail-end widths of the waveguides on the two side are respectively 0.12 μm and 0.4 μm, with a length of 40 μm, ensuring adiabatic mode evolution. An S-shaped bending length of MZI is 14 μm, with a separation spacing of 12 μm, to ensure lossless transmission of the mode. Two arms of the MZI are 40 μm long. The phase shifter is based on a thermo-optic effect of a silicon waveguide, such that the waveguide is heated by using a metal electrode, to control a refractive index of the mode.

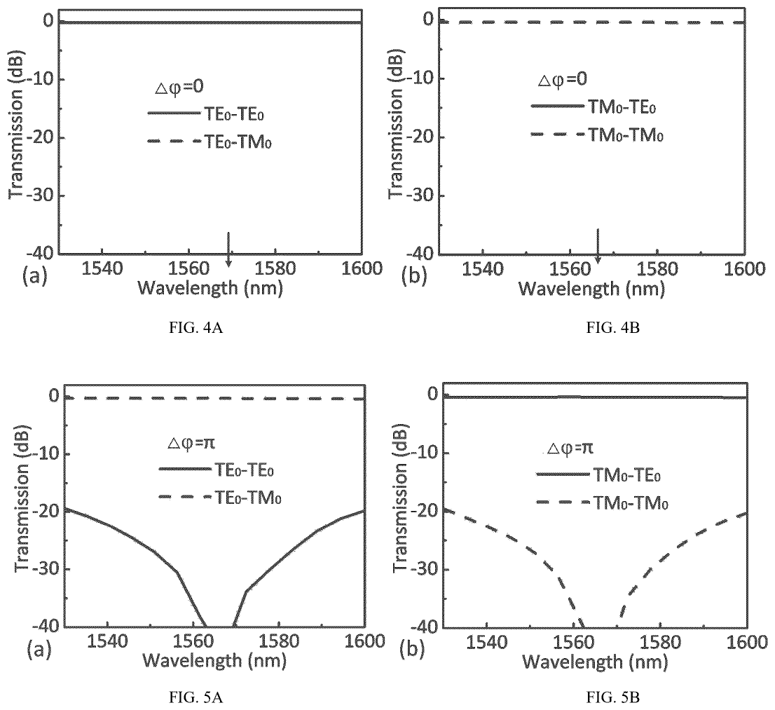

Transmission simulation is performed on performance of the device by using conversion between a TE₀ mode and the TM₀ mode as an example. When the TE₀ is input and a phase difference Δp introduced by the phase shifters of the two arms of the MZI is 0, the input TE₀ does not experience polarization conversion. A simulated transmission spectrum is shown in FIG. 4A, and switching isolation is greater than 40 dB in a wavelength range of 1530 nm to 1600 nm. When the TM₀ is input and the phase difference Δp introduced by the phase shifters of the two arms of the MZI is 0, the input TM₀ does not experience the polarization conversion. A simulated transmission spectrum is shown in FIG. 4B, and the switching isolation is greater than 40 dB in the wavelength range of 1530 nm to 1600 nm.

When the TE₀ is input and the phase difference Δp introduced by the phase shifters of the two arms of the MZI is π, the input TE₀ is converted into the TM₀ mode. A simulated transmission spectrum is shown in FIG. 5A, and the switching isolation is greater than 19 dB in the wavelength range of 1530 nm to 1600 nm. When the TM₀ is input and the phase difference Δp introduced by the phase shifters on the two arms of the MZI is π, the input TM₀ is converted into the TE₀ mode. A simulated transmission spectrum is shown in FIG. 5B, and the switching isolation is greater than 19 dB in the wavelength range of 1530 nm to 1600 nm. An on-chip insertion loss of the controller is less than 0.45 dB.

Similarly, an energy ratio of the TE₀ to the TM₀ is controlled by the phase shifters of the two arms of the MZI, and a phase difference between the TE₀ and the TM₀ is controlled through the input/output phase shifter, such that any two polarization states can be dynamically converted. The polarization controller has a large operating bandwidth and manufacturing tolerance because its core components, namely, the polarization-dependent mode converter and the multi-mode beam splitter, are based on a principle of the adiabatic mode evolution.

The above embodiments are intended to explain the present disclosure, rather than to limit the present disclosure. Any modifications and changes made to the present disclosure within the spirit of the present disclosure and the protection scope defined by the claims should all fall within the protection scope of the present disclosure.

What is claimed is:

1. A polarization controller based on on-chip mode conversion, comprising:
an input end-face coupler, an input phase shifter, an input polarization-dependent mode converter, a multi-mode 1×1 Mach-Zehnder interferometer (MZI) with a 1×2 multi-mode beam splitter, an output polarization-dependent mode converter, an output phase shifter, and an output end-face coupler, wherein an output end of the input end-face coupler is connected to an input end of the input polarization-dependent mode converter through the input phase shifter, an output end of the input polarization-dependent mode converter is connected to an input end of the multi-mode 1×1 MZI, an output end of the multi-mode 1×1 MZI is connected to an input end of the output polarization-dependent mode converter, and an output end of the output polarization-dependent mode converter is connected to the output end-face coupler through the output phase shifter; and
the input end and the output end of the multi-mode 1×1 MZI are respectively connected to the input polarization-dependent mode converter and the output polarization-dependent mode converter through a multi-mode beam splitter and a polarization-dependent mode converter to form a polarization insensitive beam splitting structure.

2. The polarization controller based on on-chip mode conversion according to claim 1, wherein the multi-mode 1×1 MZI comprises an input-end 1×2 multi-mode beam splitter, an input-end S-shaped bent waveguide, a phase shifter, an output-end S-shaped bent waveguide, and an output-end 2×1 multi-mode beam combiner; wherein the output-end 2×1 multi-mode beam combiner and the input-end 1×2 multi-mode beam splitter are symmetrically arranged at an end portion of the multi-mode 1×1 MZI; an input end of the input-end 1×2 multi-mode beam splitter is connected to the input polarization-dependent mode converter, and two output ends of the input-end 1×2 multi-mode beam splitter are respectively connected to one end of phase shifters through an S-shaped bent waveguide; and the other end of these two phase shifters are respectively connected to two input ends of the output-end 2×1 multi-mode beam combiner through an S-shaped bent waveguide respectively, and an output end of the output-end 2×1 multi-mode beam combiner is connected to the output polarization-dependent mode converter.

3. The polarization controller based on on-chip mode conversion according to claim 1, wherein a core region of the input polarization-dependent mode converter/the output polarization-dependent mode converter is a graded tapered waveguide with a vertical asymmetry cross-section, the graded tapered waveguide widens gradually, a narrow end of the graded tapered waveguide is connected to the input phase shifter/the output phase shifter, and a wide end of the graded tapered waveguide is connected to the multi-mode 1×1 MZI; and the width of the narrow end and the width of the wide end of the graded tapered waveguide span the width of hybridization region between TM₀ and TE₁ modes.

4. The polarization controller based on on-chip mode conversion according to claim 3, wherein the graded tapered waveguide with the vertical asymmetry cross-section is of a tapered ridge waveguide structure, a waveguide structure with unequal refractive indices for upper and lower cladding layers, or a waveguide structure with a non-perpendicular inclined sidewall.

5. The polarization controller based on on-chip mode conversion according to claim 2, wherein the input-end 1×2 multi-mode beam splitter and the output-end 2×1 multi-mode beam combiner are of a Y-branch structure, and the Y branch structure comprises a first adiabatically evolved waveguide, a second adiabatically evolved waveguide and a third adiabatically evolved waveguide, wherein the first adiabatically evolved waveguide is located in a middle between the second adiabatically evolved waveguide and the third adiabatically evolved waveguide to serve as a central waveguide, the second adiabatically evolved waveguide and the third adiabatically evolved waveguide on two sides of the central waveguide are symmetrical beam splitting waveguides, the central waveguide narrows from one end of the polarization-dependent mode converter to a center of the multi-mode 1×1 MZI, each of the symmetrical beam splitting waveguides widens from the same end of the polarization-dependent mode converter to the center of the multi-mode 1×1 MZI, and a gap exists between the central waveguide and each of the second adiabatically evolved waveguide and the third adiabatically evolved waveguide.

6. The polarization controller based on on-chip mode conversion according to claim 5, wherein a wide end of the central waveguide is connected to a wide end of a graded tapered waveguide, and a width of the wide end of the graded tapered waveguide is identical to a width of the wide end of the central waveguide; and wide ends of the symmetrical beam splitting waveguides are respectively connected to respective S-shaped bent waveguides.

7. The polarization controller based on on-chip mode conversion according to claim 1, wherein the input end-face coupler/the output end-face coupler adopts an inverted-cone waveguide design, wherein a waveguide width gradually narrows from a center of the polarization controller towards the input/output end of the input end-face coupler/the output end-face coupler.

8. The polarization controller based on on-chip mode conversion according to claim 1, wherein the input end-face coupler, the input phase shifter, the input polarization-dependent mode converter, the multi-mode 1×1 MZI, the output polarization-dependent mode converter, the output phase shifter, and the output end-face coupler are all integrated on a same silicon substrate through a semiconductor technology.
